(19) United States
(12) Patent Application Publication
(10) Pub. No.: US 2026/0336437 A1
(43) Pub. Date: Oct. 29, 2026

(54) CHARGING SOCKET FOR AN ELECTRIC OR HYBRID VEHICLE

(71) Applicant: Kiekert Aktiengesellschaft, Heiligenhaus (DE)

(72) Inventors: Benjamin DJEDOVIC, Oberhausen (DE); Tanja SCHWINNING, Velbert (DE); Robert LANDSKRON, Monheim (DE)

(73) Assignee: Kiekert Aktiengesellschaft, Heiligenhaus (DE)

(21) Appl. No.: 19/103,635

(22) PCT Filed: Jul. 28, 2023
(86) PCT No.: PCT/DE2023/100557

§ 371 Date: Feb. 13, 2025

(30) Foreign Application Priority Data
Aug. 26, 2022 (DE) 10 2022 121 659.4

(51) Int. Cl. B60L 53/16; E05F 15/614

(52) U.S. Cl. CPC B60L 53/16; E05F 15/614; E05Y 2201/224; E05Y 2900/534

(57) ABSTRACT

The invention relates to a charging socket (1) for an electric or hybrid vehicle, comprising a first socket (3), a second socket (5), the sockets (3, 5) forming the charging socket (1) and being arranged together in a charging compartment of a motor vehicle body, and a movable charging compartment cover, wherein the charging compartment can be covered by means of the charging compartment cover, and wherein one socket (3, 5), preferably the second socket (5), can be separately closed.

The invention relates to a charging socket for an electric or hybrid vehicle comprising a first multi-pole socket, a second two-pole socket, wherein the sockets form the charging socket and are arranged together in a charging compartment of a motor vehicle body, and a movable charging compartment cover, wherein the charging compartment can be covered by means of the charging compartment cover.

Such charging sockets are preferably integrated into the body of motor vehicles and are usually arranged in a protected manner behind a movable charging compartment cover. The charging compartment cover serves on the one hand to prevent misuse of the charging socket and on the other hand to protect the charging socket from environmental influences. The charging socket is used in different design variants. The invention relates to a charging socket with a first socket for an alternating voltage and a second socket for a direct voltage connection. The sockets differ in the number of poles available and substantially in the fact that different charging currents are available for the motor vehicle.

The charging socket according to the invention has a combination of a multi-pole and a two-pole socket. Such sockets are also called Type 2 plugs for DC and AC charging and are known as EU standard plugs.

The charging socket is permanently installed in a charging compartment of a motor vehicle so that an operator is able to insert the charging plug into the charging socket of the charging compartment. Various solutions have become known from the prior art for closing the charging compartment and thus covering the charging socket.

DE 20 2021 901 685 U1 discloses a sliding and pivoting device for a vehicle flap to cover a charging socket. To release the charging socket, which is also referred to here as an interface or charging module, the vehicle flap can first be moved using a sliding device and then moved using a pivot device. The charging socket is thus released via a linear displacement followed by pivoting of the vehicle flap.

From DE 10 2020 209 607A1, a closure arrangement for closing a tank compartment of a body of a motor vehicle has become known, wherein a cover element is displaceably moved in the body by means of a linear drive. The closure arrangement here performs two different movements. To open the charging compartment, the charging compartment cover or cover element is first moved using a lifting movement and then carries out a longitudinal movement, thus releasing the charging socket.

From the unpublished DE 10 2021 116 318.8, a device for closing a charging device of an electric or hybrid vehicle has become known, comprising a connector half arranged in the vehicle for connection to another connector half, an electrically drivable closing device, wherein in an unactuated state of the connector half an opening of the charging device can be closed by means of the closing device, and wherein the closing device can be mechanically brought into engagement with the further connector half inserted into the connector half, wherein a position of the closing device can be detected by means of a sensor. In two different embodiments, it is described that the charging compartment cover is arranged to be movable, so that the charging socket or the charging compartment can be closed at least in part even during the charging process.

The solutions known from the prior art have proven to be of value. However, the prior art reaches its limits when it comes to protecting the socket that is not in use. In particular, if charging has to take place under weather and/or environmental influences, if charging is carried out via one socket, the other socket can be protected only to a limited extent from environmental influences and misuse. This is where the present invention comes in, aiming to demonstrate improvements.

The object of the invention is to provide an improved charging socket for an electric or hybrid vehicle. In particular, the object of the invention is to provide protection for a socket that is not in use, so that overall safe operation of the charging process can be ensured.

According to the invention, the object is achieved by the features of independent claim 1. Advantageous embodiments are specified in the dependent claims. However, it should be noted that the exemplary embodiments described in the following are not limiting; rather, any number of possible variations of the features described in the description, the claims, and the drawings are possible.

According to claim 1, the object of the invention is achieved in that a charging socket is provided for an electric or hybrid vehicle, comprising a first multi-pole socket, a second two-pole socket, wherein the sockets form the charging socket and are arranged together in a charging compartment of a motor vehicle body, and a movable charging compartment cover, wherein the charging compartment can be covered by means of the charging compartment cover, and wherein a socket, preferably the second two-pole socket, can be closed separately. The design according to the invention of the charging socket now makes it possible to partially close the charging socket so that one socket can be kept closed during charging. This offers multiple advantages, which are described in more detail below in the various embodiments.

A significant advantage of the design of the charging socket according to the invention is that the second socket, not used for charging, is closed during the charging process. This protects the unused socket from environmental influences and also from improper or abusive use. For example, in the event of moisture or precipitation in the form of rain or snow, no moisture can get into the other socket. The charging compartment cover usually covers and/or seals the charging compartment, but in the case where a charging plug is inserted, the charging compartment may not be closed or may only be partially closed. Through the use according to the invention of a separate cover for the socket not assigned to the charging process, a safe and complete closure of the other socket can be ensured and thus the other socket can be protected during the charging process.

A charging socket according to the invention is used in motor vehicles, such as passenger cars, vans, industrial trucks, cargo trucks, etc. This list is of course not limiting; rather, the charging socket can be used wherever electric or hybrid-powered vehicles or means of transport are used that are equipped with a traction battery. This also includes driverless means of transport, such as buses, work equipment, etc.

As already mentioned above, the charging socket has two sockets, one of which can be used for charging with an alternating current (AC) and a second socket that can be charged with a direct current (DC). Such sockets are well known and are certified, for example according to EU standards. The sockets are arranged next to each other in a charging compartment. This offers the advantage that a charging flap can close the charging compartment so that the passenger vehicle, for example, can form a flat surface with the charging flap. The term “charging compartment” is not to be understood as limiting, but can also include another opening or charging space in the vehicle. For example, if the charging socket is installed in the trunk of a vehicle, the charging compartment would be designed as a trunk and the charging compartment cover would be formed by the trunk cover. What is essential to the invention is that at least one socket, preferably the second DC socket, can be closed separately.

If the second socket can be closed or covered by means of a cover flap, this results in an advantageous variant embodiment of the invention. Closing the additional socket with a cover flap offers the advantage of allowing the socket to be sealed tightly. The cover flap can be in full contact with the socket outlet and thus prevent the penetration of environmental influences. The cover flap can follow the shape of the socket and thus ensure protection, with the smallest possible size, for the socket. The cover flap serves as protection, so that the cover flap can also be referred to as a protective cap or protective flap or cover cap. The purpose of the cover flap is to close the socket in sealing fashion around its outer circumference.

The cover flap is advantageously made of a plastics material. Plastics materials have the advantage that they are lightweight, can be easily formed into any shape and, as a cost-effective material, have a positive effect on the cost of the charging socket. It is also conceivable for the cover flap to have a seal, where the seal can be formed circumferentially around an edge of the socket. The seal can be mounted in one piece on the cover flap or can be designed as a fixed component of the cover flap. In this case, the cover flap would be designed as a two-component part, for example.

If the second socket can be closed in such a way that a charging plug can be inserted into the first socket, this again results in an advantageous variant embodiment of the invention. The cover flap closes the socket in such a way that the first socket is freely accessible and can function as a socket. Consequently, charging via the first socket is made possible, wherein the charging compartment cover is preferably designed such that it follows the shape of the opening of the first socket. The first socket is thus completely enclosed by the housing of the charging socket and the cover flap, so that the operator has a completely open first socket available. In other words, the cover flap follows the shape of the opening of the first socket. This offers the advantage that a plug inserted into the first socket is completely sealed. This means that neither dirt nor moisture can penetrate into the second socket or into the first socket during the charging process.

In a further embodiment of the invention, the cover flap can be actuated in an electrically driven manner. The cover flap is moved by means of an electric drive and preferably by means of an electric drive and at least one gear mechanism stage. Electrical energy is available in the motor vehicle, so that a movement can be initiated in the cover flap by means of a microdrive. The cover flap can be moved in a linear pivoting motion or in a combined movement of, for example, linear movement and pivoting movement. Depending on the arrangement of the cover flap, the cover flap is then moved over the preferred second socket and finally brought into contact with an opening of the second socket, sealing it.

A further embodiment of the invention results when the cover flap can be lifted off the second socket by means of a lifting movement and can be moved out of an overlap region with the second socket by means of a second pivoting movement. The combined movement of a lifting movement and a pivoting movement makes it possible to achieve the most optimal seating of the cover flap over the opening of the second socket. The cover flap covers the opening of the second socket in such a way that a sealing cover can be realized. According to the invention, however, it is also conceivable that the cover flap fits with a positive fit into the opening of the second socket, so that the cover flap is flush with a housing of the charging socket.

It is also conceivable that, for example, a circumferential recess is arranged in the housing of the charging socket into which the cover flap can be inserted. The first lifting movement then allows the cover flap to be released from the seating with the housing of the charging socket and then to move into a region in which the cover flap can be pivoted. A pivoting movement can be of an angle of more than 90°, preferably 120°, so that the cover flap can be pivoted completely out of the region of the openings of the sockets. In the case of a linear movement and/or a pivoting movement and/or a flap movement of the cover flap, the cover flap is always moved far enough so that the second socket is freely accessible.

In an advantageous variant embodiment of the invention, the cover flap is connected to a drive shaft, wherein the drive shaft can be actuated by means of a drive wheel. The drive shaft is preferably arranged at a lateral end of the cover flap, so that a pivoting movement of the cover flap allows the cover flap to be pivoted out of the region of the openings of the sockets. By using a drive shaft, it is possible to arrange the electric drive at a distance from the socket region, so that a structurally advantageous and space-saving arrangement of the electric drive is possible. A drive wheel works together with the drive shaft, wherein the drive wheel is engaged by means of an electric motor and a downstream gear mechanism. The drive wheel allows the movement of the drive shaft in the axial direction as well as a rotational movement of the drive shaft. The drive shaft itself preferably extends along the socket so that the drive mechanism can be arranged in a region behind the socket.

If the drive shaft has a control contour and the cover flap can be moved linearly by means of the control contour and a linear guide, the cover flap can be moved safely, quickly and precisely. The drive shaft and drive wheel work together in such a way that a linear movement of the drive shaft can be realized by means of the control contour attached to the drive shaft. The drive wheel can engage the control contour in such a way that the drive shaft can be moved along its central axis. For this purpose, the drive shaft is mounted in a linear guide in a housing so that it can pivot and can be displaced linearly.

Continuing the idea of the invention, the drive shaft has at least one stop and the linear guide has a freewheel region, wherein a pivoting movement of the charging flap can be limited and guided by means of the stop. In connection with the embodiment, the drive shaft can also be referred to as a control shaft in interaction with the linear guide. A stop and guide means is provided on the drive shaft and can be guided through the linear guide in a linear movement. After the cover flap has been set up, the stop reaches a stop point in the linear guide, so that further linear displacement is prevented. At the same time, the stop reaches a freewheel region through which the drive shaft can be pivoted. The linear guide therefore also serves as a guide for the pivoting movement. This pivoting movement is realized by the drive wheel being further driven and the drive wheel reaching a stop surface on the control contour of the drive shaft, by means of which the drive shaft can be pivoted. If the drive shaft is moved linearly via the control contour of the drive shaft, a pivoting movement can be initiated in the drive shaft at the same time by means of the drive wheel. The drive wheel, drive shaft and the guide in the housing thus allow a lifting movement of the cover flap and a pivoting of the cover flap out of the opening region of the sockets.

In a further embodiment of the invention, the drive wheel has at least one further stop and/or at least one locking means, so that a closing movement of the cover flap can be realized by means of the drive wheel. The drive wheel can, for example, move the cover flap back to its original position by means of a backward movement. For this purpose, the drive wheel has a locking means or interacts with the locking means in such a way that when the end position of the cover flap is reached, i.e., in the fully pivoted position, the locking means engages in a contour of the drive shaft. If the drive wheel is now moved back by means of the electric drive, the pivoting movement of the cover flap can be pivoted until an end position is reached in the linear guide or the pivot guide. When the linear part of the linear guide is reached, the locking device disengages and the drive wheel can be moved linearly back to its starting position via another control curve on the drive shaft. The cover flap then closes the socket again. The design according to the invention of the charging socket makes it possible to protect the sockets even during the charging process, so that safe and long-term use of the charging socket is made possible.

In a further embodiment of the invention, the drive wheel is designed as part of a spindle drive. A spindle drive offers the advantage that linear movements can be produced very evenly and precisely. Spindle drives also have a high degree of smoothness and thus allow continuous movement of the drive shaft. A positioning movement of the cover flap can thus be realized with the simplest constructive means and in the smallest possible size.

A very small drive and thus a structurally favorable design is achieved in particular when the drive shaft is designed as a spindle nut and the drive wheel is designed as a spindle. The drive shaft thus functions directly as a gear mechanism component, whereby the smallest possible number of components is required to provide a linear drive. In addition, the design of the drive shaft as a spindle nut allows the cover flap to be moved very precisely and evenly. In addition, large actuating forces can be achieved by means of a spindle drive, so that weather influences, such as frost, and thus the sticking of the cover flap, can be overcome.

The drive shaft itself is movable, in particular linearly and rotationally movable, by means of a guide element. As in the first embodiment, the drive shaft can be guided linearly and rotationally by means of a guide element. For this purpose, the guide element has a linear groove within which the drive shaft can be moved linearly and at least one further groove by means of which a rotational movement of the drive shaft can be carried out in a guided manner. The guide element thus determines the movement sequence of the drive shaft and thus the position of the cover flap, which is connected to the drive shaft in such a way that the cover flap follows the movement of the drive shaft.

The movement of the drive shaft can be realized by means of a guide means. The drive shaft has a guide means, in particular a stop, wherein the drive shaft is movable in the guide element by means of the guide means. The movement is introduced into the drive shaft by means of the spindle drive. The guide means is part of the guide element or interacts with the guide element. The guide means can be designed, for example, as a groove or elevation and interacts with the guide element in such a way that the drive shaft executes a linear and/or pivoting movement. For this purpose, for example, a stop can be formed on the drive shaft as a guide means, so that the stop forms an elevation on the drive shaft. The stop itself is then guided in the guide element, for example a linear groove, so that the movement introduced into the drive shaft by the spindle drive results in a linear movement of the drive shaft. If the stop or the elevation reaches the end of the linear guide, the rotary movement of the spindle drive is no longer converted into a linear movement; rather, the drive shaft rotates in the direction of the groove that releases the rotation. Consequently, a linear guide is formed in the guide element in the longitudinal direction of the drive shaft and a groove is arranged circumferentially in the guide element, wherein the circumferential groove realizes a rotational movement of the drive shaft and thus of the cover flap. In this respect, the guide element of the spindle drive corresponds to the guide element of the drive via the control curve. Ultimately, only one alternative drive for moving the cover flap is shown in this embodiment.

In both embodiments, the cover flap is moved linearly and/or rotationally by means of an electric motor, a gear mechanism, and the guide element. The movement is of course not limited to a linear and subsequent rotary movement; rather, depending on the design and the available space requirements, a rotary movement can also begin immediately when the cover flap is detached from the housing of the charging socket, so that a parallel rotary and linear movement can be introduced into the cover flap. The use of a two-stage gear mechanism has proven to be advantageous here. It is also conceivable to use more than two gear mechanism stages in order to be able to initiate suitable positioning movements or actuating speeds in the cover flap. It is conceivable, for example, to provide a worm drive directly on the electric motor, wherein the worm drive ends in a further gear mechanism stage, and the second gear mechanism stage, for example, drives the spindle nut. Depending on the space requirement, the force required to move the cover flap, the actuating speed and/or the required pivot angle or pivoting movement, different gear mechanisms can be used.

The invention is explained in more detail below with reference to the accompanying drawings on the basis of a preferred exemplary embodiment. However, the principle applies that the exemplary embodiment does not limit the invention, but is merely an advantageous design. The features depicted can be implemented individually or in combination with further features of the description as well as what is claimed-individually or in combination.

### IN THE FIGURES

FIG. 1 is a three-dimensional view of a charging socket designed according to the invention, with the cover flap shown in a closed position,

FIG. 2 shows the charging socket according to the invention shown in FIG. 1, wherein the cover flap is shown in a position lifted away from the second socket,

FIG. 3 shows the charging socket according to the invention, with the cover flap shown in a fully pivoted position,

FIG. 4 is a detail view of the drive shaft and the drive wheel in a position in which the cover flap is completely pivoted,

FIG. 5 is a detail view of the linear guide in engagement with the drive shaft,

FIG. 6 is a detail view of the drive wheel and one end of the drive shaft in a position in which the cover flap is in the fully pivoted position,

FIG. 7 is a three-dimensional view of an alternative embodiment of a drive of the cover flap in the form of a spindle drive, and

FIG. 8 is a view of the spindle drive according to FIG. 7, wherein the spindle drive is shown in a position during the pivoting movement of the cover flap.

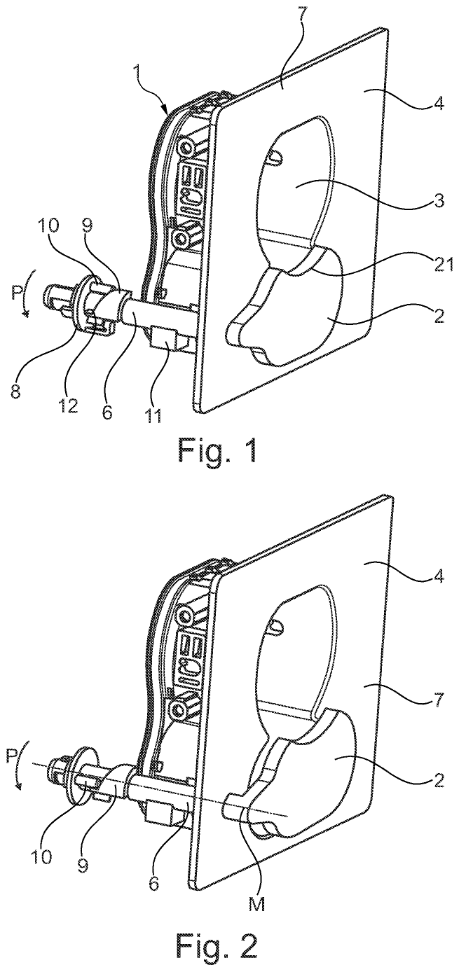

FIG. 1 shows a charging socket 1 in a three-dimensional view. The charging socket 1 is partially closed by a cover flap 2, so that only a first socket 3 is in an open position. The charging socket 1 is shown detached from a motor vehicle, wherein the charging socket 1 can usually be arranged behind a charging flap of a motor vehicle in a charging compartment, again not shown. The charging socket 1 has a housing 4, wherein the housing 4 contains two different sockets 3, 5. The first socket 3 is preferably a socket for charging by means of an alternating voltage, whereas the second socket 5 is suitable for charging by means of direct current.

A drive shaft 6, preferably in one piece and made of plastics material, is attached to the cover flap 2 and extends from a surface 7 of the housing 4 in the direction of the housing 4. The closing device 6 interacts with a drive wheel 8. For example, the drive wheel 6 is engaged by the teeth of a gear mechanism, which in turn works together with an electric motor or is driven by an electric motor. The gear mechanism for driving the drive wheel 8 and the electric drive are not shown in this illustration. The drive shaft 6 has a first control contour 9, which works together with the drive wheel 8 and in particular a drive pin 10. Also visible is a guide element 11 for the linear and pivoting guidance of the cover flap 2. The guide element 11 can, for example, be fixedly accommodated in a housing of the charging socket 1 or a body of the motor vehicle. The guide element is in any case arranged stationary with respect to the drive shaft 6 in the motor vehicle.

If the drive wheel 8 is now acted upon by a force from an electric motor, the drive wheel 8 moves in the direction of the arrow P, in a counterclockwise direction in the present embodiment.

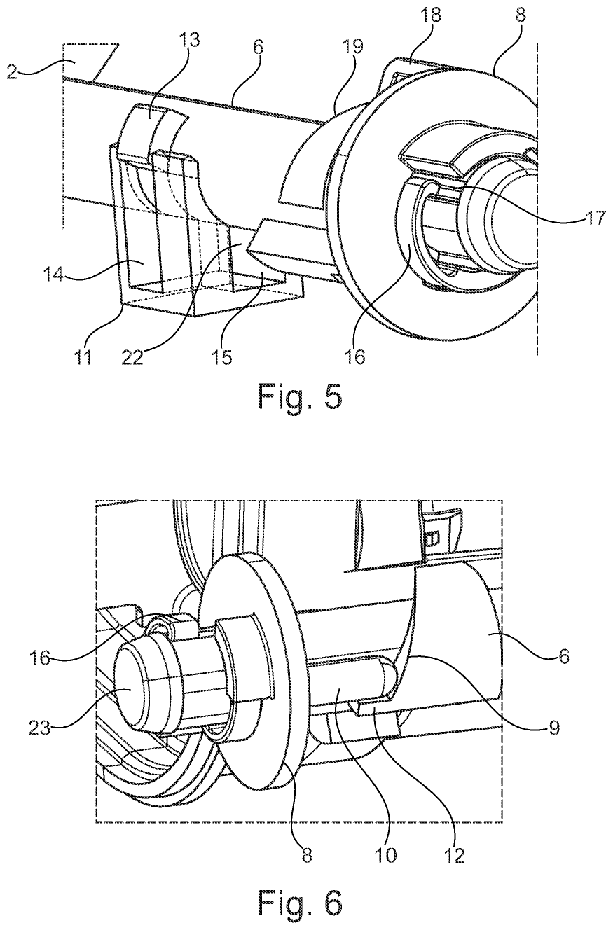

By the movement of the drive wheel, as shown in FIG. 2, the drive pin reaches the pivot position shown in FIG. 2. As can be clearly seen from the figures, here there is a pivot angle of the drive wheel 8 of approx. 80-120° or approx. 90°. The drive pin 10 interacts with the control contour 9 and moves the drive shaft 6 along a central axis M of the drive shaft 6. Due to the linear displacement of the drive shaft 6, the cover flap 2 experiences a lifting movement so that the cover flap 2 is lifted off the surface 7 of the housing 4. This moves the cover flap from the sealing position in FIG. 1 to the raised position in FIG. 2. When the linearly movable end position is reached, the drive pin 10 comes into contact with a stop surface 12 on the control contour. At the same time, and this can be seen more clearly in FIG. 5, a stop 13 is moved into a freewheel region 14, wherein the freewheel region 14 is arranged at one end of a linear guide 15.

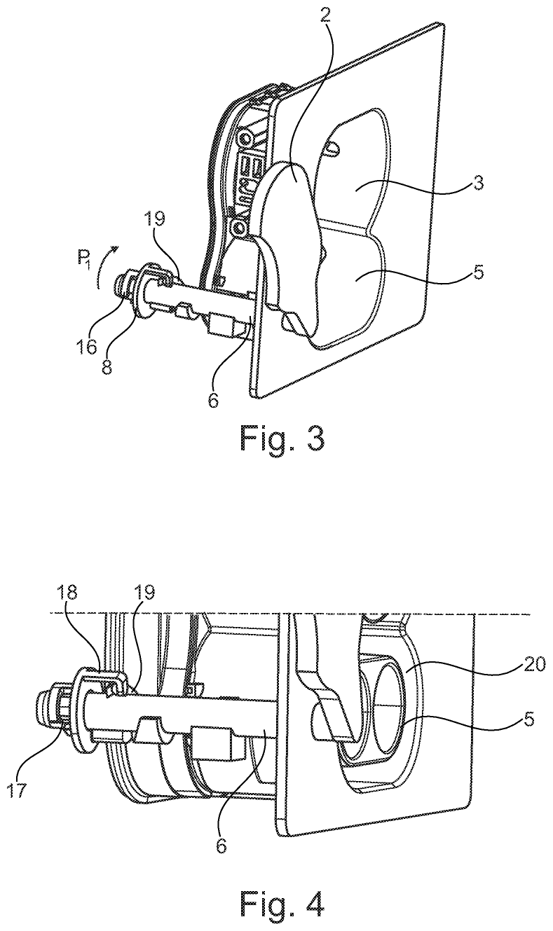

If the drive wheel 8 is now driven further counterclockwise in the direction of the arrow P, the stop surface 12 in combination with the drive pin 10 carries the drive shaft along with it and pivots the drive shaft 6, also counterclockwise. The resulting pivoting movement of the cover flap 2 is shown in the final position in FIG. 3. FIG. 3 thus shows the end position of the cover flap 2 after pivoting the drive shaft by approximately 120°. By pivoting the cover flap 2, the second socket 5 is completely exposed. The operator is now also able to use the DC socket 5.

When the end position of the cover flap 2 is reached, a locking means 16 engages in a locking contour 17 in the drive shaft 6. The drive wheel 8 is now locked with the drive shaft 6. If, starting from this deflected position of the cover flap 2, the drive wheel 8 is now driven clockwise in the direction of the arrow P1, the drive wheel 8 carries the drive shaft 6 with it and pivots the cover flap back into its starting position above the second socket 5. When the end position or starting position of the cover flap 2 is reached and the drive wheel 5 is further driven, the stop 13 comes into contact with the linear guide 15 so that the locking means 16 can be moved out of the locking contour. In a further clockwise movement in the direction of the arrow P1, a drive cam 18 engages a further control contour 19 on the drive shaft 6, so that when the drive wheel 8 is driven further, the drive shaft 6 and thus the cover flap 2 are again moved in the direction of the surface 7 of the housing. The cover flap is now back in its original position, in which the cover flap 2 covers the opening 20 of the socket 5. As can be clearly seen in FIG. 1, the cover flap 2 completely covers the opening 20 and the cover flap 2 has a recess 21 so that a complete sealing of a charging plug in engagement with the first socket 3 is possible.

FIG. 5 shows an enlarged detail view of the drive shaft 3 and the drive wheel 8. The locking means 16 is in engagement with the locking contour 17, from which it can be inferred that the drive shaft 6 is in the end position of the pivoting movement or at least on the way to pivoting back the cover flap 2. As can be clearly seen in FIG. 5, the pivoting movement is guided by the freewheel region 14 or a pivot guide 14. For this purpose, the stop 13 moves through the freewheel region 14 until the stop 13 comes into contact against a stop surface 22 in the guide element 11. When the stop surface 22 is reached, the drive cam 18 then engages in the control contour 19 and moves the stop 13 along the linear guide 15, which results in the cover flap moving along the central axis M and the cover flap 2 coming into sealing contact with the surface 7 of the housing.

FIG. 6 shows a further detailed view of an axial end 23 of the drive shaft 6 and the drive wheel 8. The drive pin 10 can be seen in contact with the stop surface 12 at the end of the control contour 9. The position of the locking means 16 again indicates the position of the cover flap 2, which is in the lifted-off position and in an opening position, i.e., in a position pivoted away from the opening 20 of the socket 5.

The design according to the invention of the charging socket 1 now makes it possible to provide protection during charging for the socket that is not in use and, moreover, to allow automated charging of a motor vehicle by enabling the cover flap 2 to be pivoted in automated fashion out of the region of the socket 5 by an electric motor and by means of a control system.

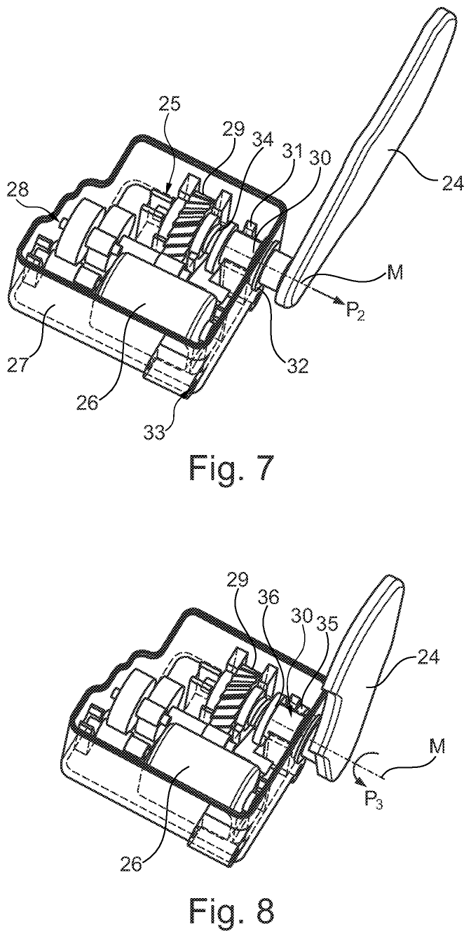

FIG. 7 shows an alternative drive for the cover flap 24 in the form of a spindle drive 25. An electric motor is housed in a drive housing and drives a multi-stage gear mechanism 28. A spindle nut 29 is driven via the gear mechanism stages of the gear mechanism 28, wherein the spindle nut acts directly on the drive shaft 30. The drive shaft 30 is in turn connected to the cover flap 24. Also visible is a guide element 31 which is operatively connected to the drive shaft 30. A sealing means 32, for example a sealing ring, seals the drive shaft 30 so that the drive housing 27 is protected against external influences. The drive housing 27 can be connected to the housing 4 of the charging socket, for example via fastening means 23. The drive housing 27 is preferably made of a plastics material and the fastening means 33 can, for example, be screw openings that enable fastening to the charging socket 1.

FIG. 7 shows the position assumed by the cover flap 24 when the cover flap 24 has been moved linearly in the direction of the arrow P2. A part of the threading 34 of the spindle drive 25 can be seen. In other words, the drive shaft 30 has already been moved in the direction of the arrow P2, so that in this position the cover flap 24 is already lifted off the surface 6 of the charging socket 1.

FIG. 8 shows a further movement of the cover flap 24, wherein the cover flap 24 executes a pivoting movement. The spindle nut 29 is further driven by the electric motor 26, wherein a stop 35 on the drive shaft 30 is guided in the guide element 31. The guide element 31 has a linear guide in which the stop 35 is guided in the direction of the arrow P2. After reaching the end of the linear guide, the stop 35 is no longer prevented from rotating, so that the stop 35 can perform a rotary movement along a freewheel region. The stop 35 in combination with the guide element 31 thus enables a linear movement as well as a pivoting movement of the cover flap 24. In the rotational movement shown in FIG. 8, the cover flap 24 is moved about a central axis M of the drive shaft 30 in the direction of the arrow P3.

It will be understood that, for example, a control contour 36 may be present by means of which a microswitch can be actuated. However, the control contour can also serve as an end stop, for example for a linear movement of the drive shaft 30. Movements in the range between 2 mm and 12 mm, preferably between 3 and 10 mm, can be realized as positioning movements in the direction of arrow P2. As described above, pivoting movements between an angle of 80-150°, preferably between 90° and 120°, can be set or realized. The angles to be set can be set by means of the stop 3, 35 or by means of the control contour 9, 19, 36 and/or by means of further stops, for example on the cover flap 2, 24.

### LIST OF REFERENCE SIGNS

1 Charging socket
2, 24 Cover flap
3, 5 Socket
4 Housing
5, 30 Drive shaft
6 Surface
8 Drive wheel
9, 19, 36 Control contour
10 Drive pin
11, 31 Guide element
12, 22 Stop surface
13, 35 Stop
14 Freewheel region
15 Linear guide
16 Locking means
17 Locking contour
18 Drive cams
20 Opening
21 Recess
23 Axial end of the drive shaft
25 Spindle drive
26 Electric motor
27 Drive housing
28 Gear mechanism
29 Spindle nut
32 Sealing ring
33 Fastening means
34 Spindle threading
P, P1, P2, P3 Arrow
M Center axis

1. A charging socket for an electric or hybrid vehicle arranged in a charging compartment of a motor vehicle body, the charging socket comprising:
a first multipole socket,
a second two-pole socket,
wherein the first multipole socket and the second two-pole socket are arranged together in the charging compartment of the motor vehicle body, and
a movable charging compartment cover configured to cover the charging compartment,
wherein at least one of the first multipole socket and the second two-pole socket is configured to be separately closed from the other.

2. The charging socket according to claim 1, wherein the charging compartment cover includes a cover flap configured to close at least one of the first multipole socket and the second two-pole socket.

3. The charging socket according to claim 2, wherein the cover flap is made of a plastics material.

4. The charging socket according to claim 1, wherein the charging socket is configured to be closed by inserting charging plug.

5. The charging socket according to claim 2, wherein the cover flap is actuated in an electrically driven manner.

6. The charging socket according to claim 2, wherein the cover flap is configured to be lifted off the charging socket by a first lifting movement and is further configured to be moved out of an overlap region with the charging socket by a second pivoting movement.

7. The charging socket according to claim 2, further comprising a drive shaft, a drive wheel, and a guide element wherein the cover flap is connected to the drive shaft, and wherein the drive shaft is actuated by the drive wheel.

8. The charging socket according to claim 7, wherein the drive shaft has a control contour and the cover flap is linearly movable by the control contour and the guide element.

9. The charging socket according to claim 7, wherein the drive shaft has at least one stop and the guide element has a freewheel region, wherein a pivoting movement of the cover flap is be limited and guided by the at least one stop and the freewheel region.

10. The charging socket according to claim 7, wherein the drive wheel has at least one further stop and/or at least one locking means, such that a closing movement of the cover flap is realized by the drive wheel.

11. The charging socket according to claim 7, further comprising a spindle drive, wherein the drive wheel is part of the spindle drive.

12. The charging socket according to claim 11, wherein the drive shaft is designed as a spindle thread and the drive wheel as a spindle nut.

13. The charging socket according to claim 11, wherein the drive shaft is movable by the guide element, linearly and/or driven by a motor.

14. The charging socket according to claim 11, wherein the drive shaft has a stop, and the drive shaft is movable in the guide element by the stop.

15. The charging socket according to claim 7, further comprising a motor and a gear mechanism between the motor and the cover flap, wherein the cover flap is linearly movable by the motor, the gear mechanism, and the guide element.

16. The charging socket according to claim 2, wherein the cover flap is designed as two-component part.

17. The charging socket according to claim 2, wherein the cover flap includes a seal.

18. The charging socket according to claim 8, wherein the guide element is a linear guide.

19. The charging socket according to claim 7, further comprising a motor and a gear mechanism between the motor and the cover flap, wherein the cover flap is rotationally movable by the motor, the gear mechanism, and the guide element.
